(19) United States
(12) Patent Application Publication
(10) Pub. No.: US 2007/0011163 A1
(43) Pub. Date: Jan. 11, 2007

(54) Messaging Handling Method and System

(75) Inventors: Andrew David Banks, Romsey (GB); David John McCann, Southampton (GB); David Postlethwaite, Horton Heath (GB); Tristram Terence Reilly, Chandlers Ford (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: New Orchard Road, Armonk, NY (US)

(21) Appl. No.: 11/382,516

(22) Filed: May 10, 2006

(30) Foreign Application Priority Data
Jun. 11, 2005 (GB) 0511921.9

(51) Int. Cl. G06F 17/30

(52) U.S. Cl. 707/8

(57) ABSTRACT

A method of operating a message handling system comprises maintaining queues, receiving messages, placing each message on a queue, running one or more applications which access the queues, detecting the receipt of a message with a predefined flag, and blocking at least one application from accessing the message with the predefined flag. The blocking of at least one application from accessing the message with the predefined flag can be achieved by discarding the message with the predefined flag prior to the message being placed on a queue. In an alternative embodiment, the blocking is achieved by preventing the blocked applications from removing the message from a queue.

### FIELD OF THE INVENTION

The invention relates to information technology, and more specifically to a message handling method and system.

### BACKGROUND

A message handling system normally comprises a network of linked computers or a single processing resource such as a mainframe computer with different logical components. The role of a message handling system is to maintain one or more queues of messages, to receive messages, and to place each message on a queue. The system will run one or more program applications, which access the queues, taking the messages from the queues and processing them.

In this messaging environment, there may be a need to send messages that have the sole purpose of performing diagnostic duties. The problem with doing so is that in such cases the messages may be received by a processing application, which is not always desirable.

### SUMMARY

According to a first aspect of the present invention, there is provided a method of operating a message handling system comprising maintaining one or more queues, receiving messages, placing each message on a queue, running one or more applications which access each queue, detecting the receipt of a message with a predefined flag, and blocking at least one application from accessing the message with the predefined flag.

According to a second aspect of the present invention, there is provided a message handling system comprising one or more queue managers arranged to maintain one or more queues, to receive messages, and to place each message on a queue, and one or more applications arranged to access each queue, a queue manager being further arranged to detect the receipt of a message with a predefined flag, and to block at least one application from accessing the message with the predefined flag.

According to a third aspect of the present invention, there is provided a computer program product, on a computer readable medium, for operating a message handling system and comprising instructions for maintaining one or more queues, receiving messages, placing each message on a queue, running one or more applications which access each queue, detecting the receipt of a message with a predefined flag, and blocking at least one application from accessing the message with the predefined flag.

Owing to the invention, it is possible to be able to send messages that can perform diagnostic duties without the message being processed by a processing application. The message carries a predefined flag to identify that message as a diagnostic message.

In a first embodiment, the blocking of at least one application from accessing the message with the predefined flag is achieved by discarding the message with the predefined flag, prior to the message being placed on a queue. This can be considered to be a discard on anival strategy. In this embodiment, the message is permitted to flow through the messaging system as usual, but the message is discarded immediately before it is actually put onto the local queue (not a transmission queue). A confirmation of arrival may be generated to show that the message has reached its destination, but the fact that the message is not placed on the queue prevents any processing application from receiving the message.

In a second embodiment, the blocking of at least one application from accessing the message with the predefined flag is achieved by preventing the blocked applications from removing the message from a queue. This methodology is a discard on delivery. In this embodiment, the message is again permitted to flow through the messaging system, and this time it is also placed onto the local queue. The message is discarded at the point where a processing application performs a get operation on the queue which, had the message not been discarded, would have resulted in the processing application receiving the message. This second method may be used to confirm that an application is processing the queue.

For discard on arrival, the diagnostic message is not put by the queue manager to the local queue and is instead discarded. For discard on delivery, the queue manager discards the diagnostic message at the point where the processing application performs a get operation that would otherwise result in it receiving the message.

Advantageously, the step of maintaining one or more queues comprises maintaining an input queue for receiving messages and one or more application queues for each application to access. By providing at least two queues with separate functions, the management of the system is greatly simplified.

Preferably, the step of maintaining one or more queues includes maintaining a discard queue and the step of blocking at least one application from accessing the message with the predefined flag includes placing the message on the discard queue. By providing a discard queue and placing the diagnostic message on that queue rather than a delete discard, more detailed information is obtainable concerning the workings of the message handling system.

### BRIEF DESCRIPTION OF THE SEVERAL VIEWS OF THE DRAWINGS

Embodiments of the present invention will now be described, by way of example only, with reference to the accompanying drawings, in which:

FIG. 1 is a schematic diagram of a message handling system;

FIG. 2 is a schematic diagram of a second embodiment of a message handling system; and

FIG. 3 is a flowchart of a method of operating a message handling system.

### DETAILED DESCRIPTION

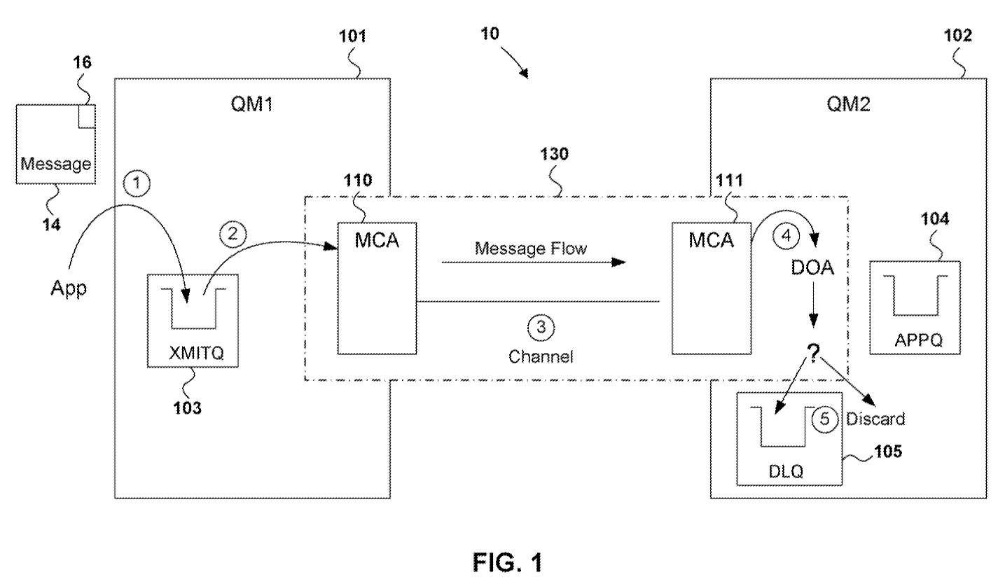

FIG. 1 shows a first embodiment of the message handling system 10. This embodiment illustrates the deletion on arrival of the diagnostic message. The system 10 includes two queue managers QM1 (101) and QM2 (102). The first queue manager QM1 maintains an input queue XMITQ (103), and the second queue manager QM2 maintains two queues, APPQ (104), effectively an output queue, and DLQ (105), a discard queue.

A channel (130) may be present, and one or more message channel agents (MCAs 110, 111) are present on each queue manager. The MCAs are responsible for transferring messages from transmit queues on the sending queue manager QM1, to destination queues on the receiving queue manager QM2. Overall, the message handling system 10 is arranged to maintain the queues, to receive messages, and to handle the messages between the queues.

The message handling system 10 also includes one or more applications, which are arranged to access the output queue APPQ. The applications will acquire messages from the queue APPQ for the purpose of carrying out work, generated as a result of the contents of the message. For example, in a message handling system supporting a shopping website, a message may constitute an order from a customer, which will be accessed by an application handling finance details of customers, and so on.

In order to carry out diagnostic work on the message handling system, a message 14 is generated that includes a flag 16 to designate the message 14 as not being an ordinary message. The queue manager QM2 is further arranged to detect the receipt of any message 14 with the predefined flag 16. The detection of the diagnostic message 14 is used to block the applications from accessing the message 14 with the predefined flag 16. This prevents the applications from attempting to carry out any work on the message 14.

In the embodiment shown in FIG. 1, steps 1 to 5 are carried out in the diagnostic method; these steps are illustrated in the Figure as numerals within circles. Step 1 shows the arrival of the diagnostic message 14 at the queue manager QM1 of the message handling system 10. The message 14, with its flag 16, is placed on the queue XMITQ.

The MCA running on QM1 will handle the message 14 as if it is a standard message, at step 2 and will pass the message 14 (step 3) to the MCA running on the target queue manager QM2. However, the MCA running on QM2 will block the applications from accessing the message 14 by discarding the message 14 on arrival (step 4). This can be achieved in one of two ways. In the first way, the message 14 can be placed on a discard queue DLQ (step 5); in the second way, the message 14 can be simply discarded. The discarding comprises deletion from memory of the message 14.

In the embodiment of FIG. 1, the message 14 never reaches the output queue APPQ, and the applications being run by the queue manager QM2 will access that queue in their normal fashion, without interruption to their running, when the diagnostic message 14 is being sent through the system.

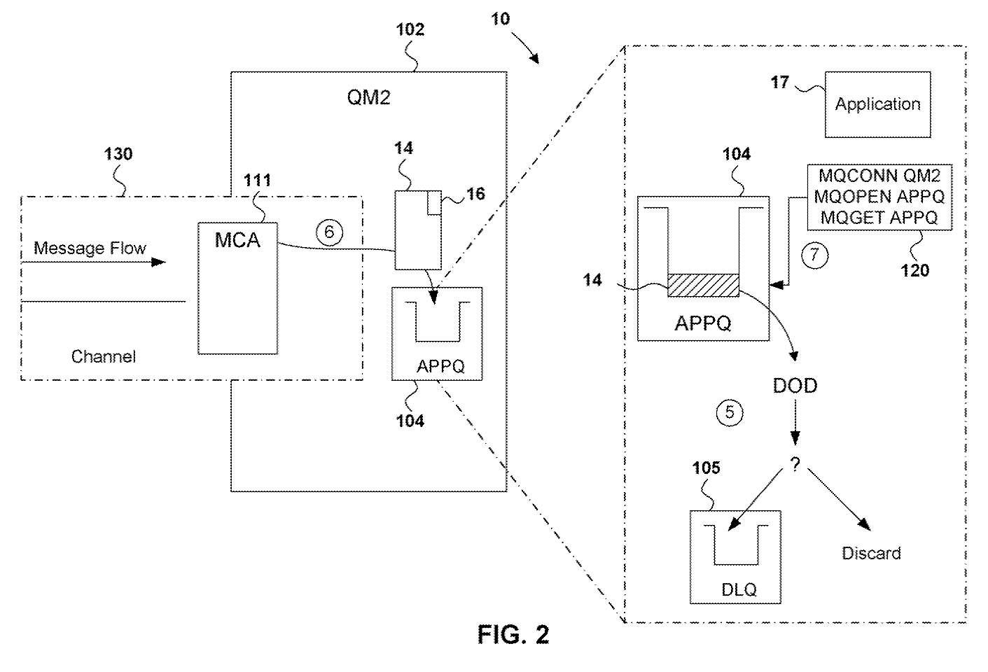

FIG. 2 shows a second embodiment of the message handling system 10. It is essentially the same system as shown in FIG. 1, but the method of handling the diagnostic message is changed at the target queue manager QM2. The MCA on QM2, when it has received the message 14, will place that message on the application message queue APPQ (step 6). However, the applications run by the message handling system are prevented from accessing the message 14 on the queue APPQ (step 6).

An application 17, connects to the queue APPQ using the appropriate MQI verbs (120). Application 17 issues an MQGET call and at this point the queue manager QM2 checks the message 14 to determine whether predefined flag 16 is set. If the predefined flag 16 is not set, then the message 14 is delivered to application 17 as requested. If the predefined flag 16 is set, then the message 14 is discarded.

As in the first embodiment of the system 10, the message 14 will be (at step 5) either placed on a discard queue DLQ or the message 14 will be discarded directly by deletion from memory.

Diagnostic messages are primarily used to determine routing information for a message as it flows through a messaging system. This routing information will primarily comprise the location of the message as it flows through the messaging system, although timing data may also be of interest.

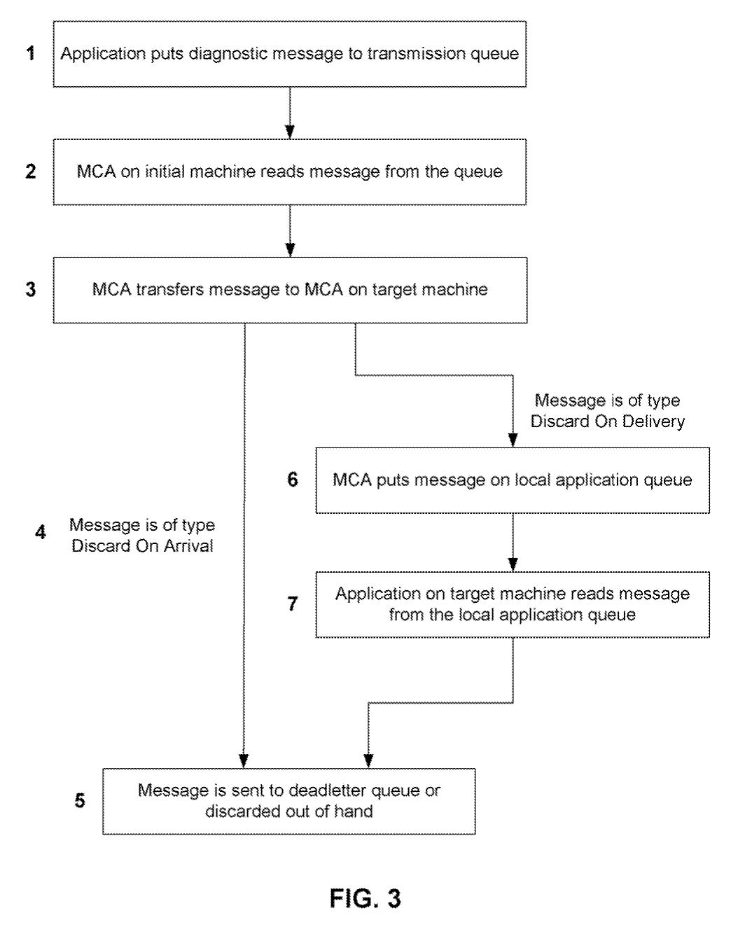

FIG. 3 shows a summary of the methodology executed by the message handling system 10. The series of steps 1 to 5 are those carried in the first embodiment, described in FIG. 1, which relates to the discard on arrival of the message 14. The steps 1, 2, 3, 6, 7 and 5 are those carried out in the second embodiment. The second embodiment is shown in FIG. 2 and relates to the discard on delivery of the message 14.

What is claimed is:

1. A method of operating a message handling system, the method comprising: maintaining queues; receiving messages; placing the messages on the queues; running applications which access the queues; detecting receipt of messages with a predefined flag; and blocking applications from accessing messages with the predefined flag.

2. A method according to claim 1, wherein blocking applications from accessing messages with the predefined flag is achieved by discarding messages with the predefined flag without allowing the messages with the predefined flag to be placed on queues.

3. A method according to claim 1, wherein blocking applications from accessing messages with the predefined flag is achieved by preventing applications from removing messages with the flag from queues.

4. A method according to claim 1, wherein maintaining queues comprises maintaining an input queue for receiving messages and application queues for the applications to access.

5. A method according to claim 1, wherein maintaining queues includes maintaining a discard queue; and wherein blocking applications from accessing message with the predefined flag includes placing messages with the predefined flag on the discard queue.

6. A message handling system, comprising: queue managers arranged to maintain queues, to receive messages, and to place messages on queues; and applications arranged to access the queues; wherein a queue manager detects receipt of messages with a predefined flag and blocks applications from accessing the messages with the predefined flag.

7. A system according to claim 6, wherein the queue manager is arranged, when blocking an application from accessing messages with the predefined flag, to discard messages with the predefined flag without allowing the messages with the predefined flag to be placed on queues.

8. A system according to claim 6, wherein the queue manager is arranged, when blocking applications from accessing message with the predefined flag, to prevent blocked applications from removing messages with the predefined flag from queues.

9. A system according to claim 6, wherein the queue manager is arranged to maintain an input queue for receiving messages, and application queues for applications to access.

10. A system according to claim 6, wherein the queue manager is arranged to maintain a discard queue, and, when blocking applications from accessing messages with the predefined flag, to place message with the predefined flag on the discard queue.

11. A computer program product for operating a message handling system, the computer program product comprising a computer readable medium having computer readable program code embedded therein, the computer readable medium comprising: computer readable program code configured to maintain queues; to receive messages; to place messages on queues; to run applications that access the queues; to detect receipt of messages having a predefined flag; and to block applications from accessing messages with the predefined flag.

12. A computer program product according to claim 11, wherein the computer readable program code configured to block applications from accessing messages with the predefined flag comprises computer readable program code configured to discard messages with the predefined flag without allowing the messages with the predefined flag to be placed on queues.

13. A computer program product according to claim 11, wherein the computer readable program code configured to block applications from accessing messages with the predefined flag comprises computer readable program code configured to prevent blocked applications from removing messages with the flag from queues.

14. A computer program product according to claim 11, wherein the computer readable program code configured to maintain queues comprises computer readable program code configured to maintain an input queue for receiving messages and application queues for applications to access.

15. A computer program product according to claim 11, wherein the computer readable program code configured to maintain queues includes computer readable program code configured to maintain a discard queue; and wherein the computer readable program code configured to block applications from accessing messages with the predefined flag includes computer readable program code configured to place messages with the flag on the discard queue.
